(19) United States
(12) Patent Application Publication
(10) Pub. No.: US 2015/0122137 A1
(43) Pub. Date: May 7, 2015

(54) COOKING POT AND LID THEREOF

(71) Applicant: Tall & Stout Industrial Corp., Shenzhen (CN)

(72) Inventor: KUEI-TANG CHANG, Shenzhen (CN)

(73) Assignee: Tall & Stout Industrial Corp., Shenzhen (CN)

(21) Appl. No.: 14/072,630

(22) Filed: Nov. 5, 2013

(51) Int. Cl. A47J 37/00; A47J 36/06; A47J 27/00

(52) U.S. Cl. CPC A47J 37/00; A47J 27/002; A47J 36/06
USPC 99/447; 220/573.1; 220/200

(57) ABSTRACT

In a cooking pot (1) and a lid, the cooking pot (1) includes a pot body (10) and the lid (20). The pot body (10) is formed with a chamber (11) and an engaging member (12) installed on the pot body (10). The lid (20) includes a lid body (21) and a placing member (22) protruded from the lid body (21), the lid body (21) is covered corresponding to the chamber (11), and the placing member (22) is correspondingly received in the engaging member (12), thereby achieving the effect of preventing the lid (20) from being in direct contact with a tabletop (9).

### BACKGROUND OF THE INVENTION

1. Field of the Invention

The present invention relates to a cooking pot, especially to a cooking pot and a lid thereof

2. Description of Related Art

In the conventional manner of frying food, the food would absorb excessive fat; if we eat too many fried food, our health will be affected in a negative way; thus skilled people in the art has developed a cooking pot utilizing hot air to bake and cook food thereby replacing the conventional manner of utilizing frying to cook the food, the original taste of fried food can be kept, and also the food is prevented from absorbing excessive amount of fat.

However, after the food in the cooking pot is cooked, a lid is detached from a pot body, wherein the lid still has the residual high temperature generated during the cooking process, so the lid is unable to be in direct contact with a tabletop, and the lid has to be accommodated in a lid accommodation rack for being prevented from being in direct contact with the tabletop; buying or producing the lid accommodation rack additionally would cause disadvantages such as occupying unnecessary space and increasing additional cost, and when the cooking pot is desired to be used elsewhere, the lid accommodation rack also has to be taken with, thereby causing inconvenience in use.

### SUMMARY OF THE INVENTION

The present invention is to provide a cooking pot and a lid thereof, wherein a lid body is installed with a placing member thereby achieving the effect of preventing the lid from being in direct contact with a tabletop.

Accordingly, the present invention provides a cooking pot, which includes a pot board and a lid; the pot body is formed with a chamber and an engaging member installed on the pot body; the lid includes a lid body and a placing member protruded from the lid body, the lid body is covered corresponding to the chamber, and the placing member is correspondingly received in the engaging member.

Accordingly, the present invention provides a lid of a cooking pot, which includes a lid body and a placing member protruded from the lid body.

Advantages achieved by the present invention are as followings: when the cooking pot is desired to be used for cooking food, with the design of the engaging member installed in the pot body, the placing member is able to be received in the engaging member, and the lid is enabled to be tightly combined with the pot body, thereby preventing hot wind provided by a hot wind supplying module from being leaked from the gap between the lid and the pot body.

### BRIEF DESCRIPTION OF DRAWING

FIG. 1 is a perspective view showing the cooking pot according to a first embodiment of the present invention;

FIG. 2 is a perspective exploded view showing the cooking pot according to the first embodiment of the present invention;

FIG. 3 is a schematic view illustrating the cooking pot being in use according to the first embodiment of the present invention;

FIG. 4 is another schematic view illustrating the cooking pot being in use according to the first embodiment of the present invention;

FIG. 5 is still another schematic view illustrating the cooking pot being in use according to the first embodiment of the present invention;

FIG. 6 is a schematic view showing the cooking pot according to a second embodiment of the present invention;

FIG. 7 is a schematic view showing the cooking pot according to a third embodiment of the present invention;

FIG. 8 is a schematic view showing the cooking pot according to a fourth embodiment of the present invention;

FIG. 9 is a schematic view showing the cooking pot according to a fifth embodiment of the present invention; and

FIG. 10 is a schematic view illustrating the mobile supports shown in FIG. 9 being downwardly pulled out.

### DETAILED DESCRIPTION OF THE INVENTION

Preferred embodiments of the present invention will be described with reference to the drawings.

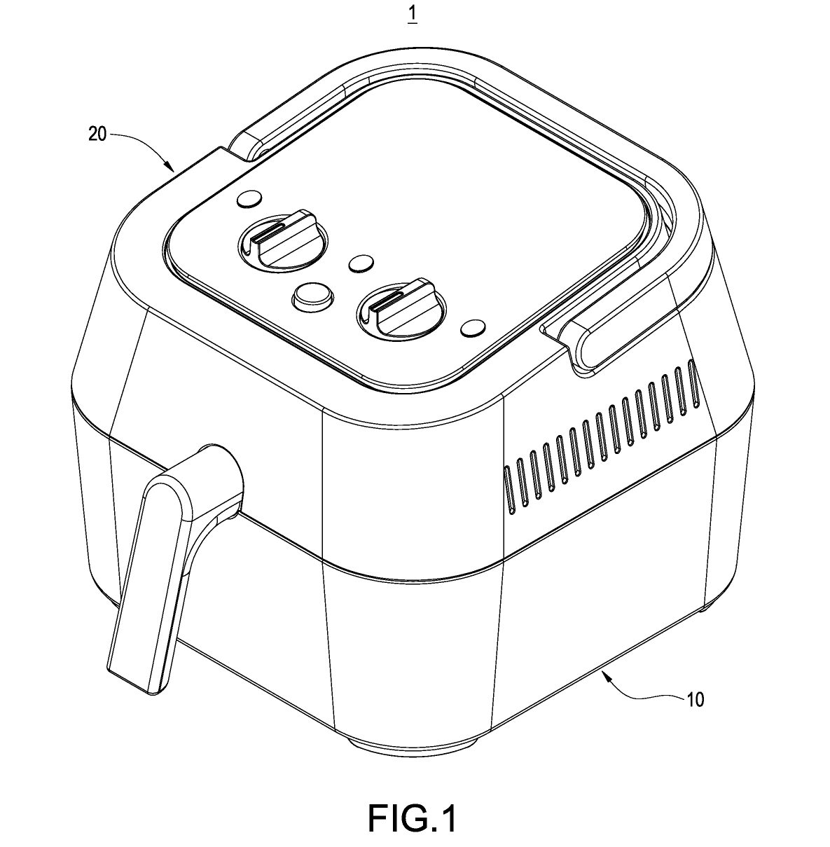

Please refer to FIG. 1, which is a perspective view showing the cooking pot according to a first embodiment of the present invention. According to the present invention, the cooking pot (1) mainly includes a pot body (10) and a lid (20).

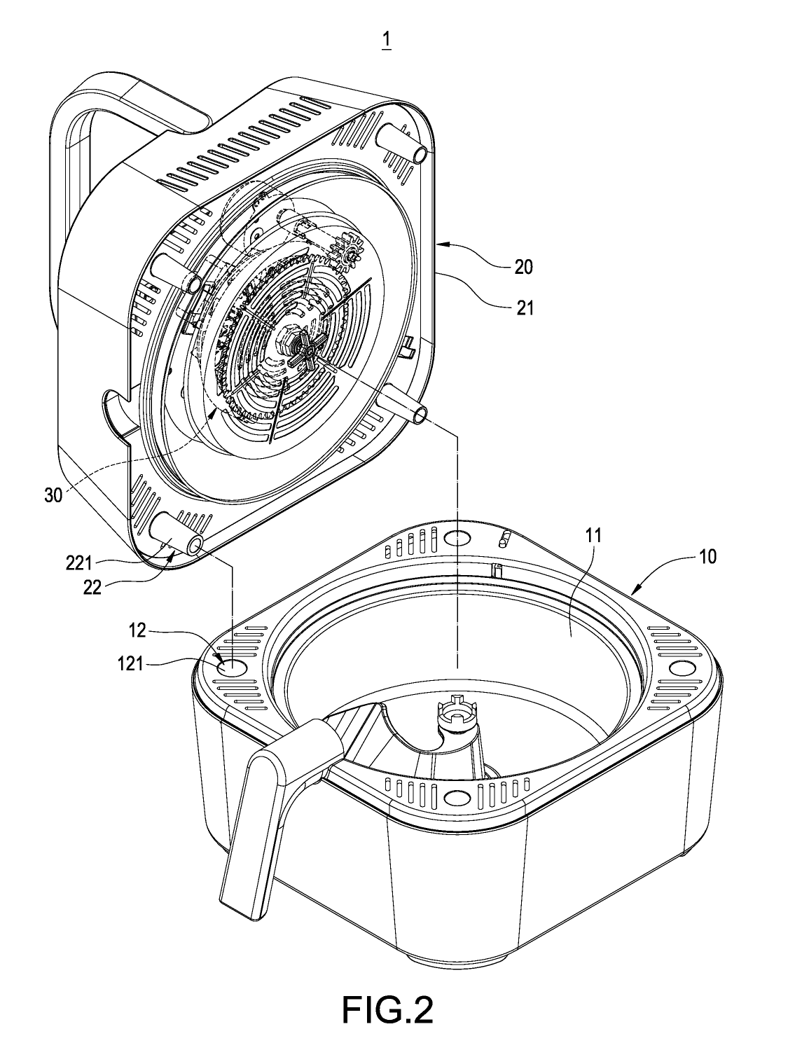

Please refer to FIG. 2, which is a perspective exploded view showing the cooking pot according to the first embodiment of the present invention. The pot body (10) is formed with a chamber (11) thereby allowing food to be accommodated in the chamber (11) of the pot body (10). The pot body (10) is installed with an engaging member (12), the engaging member (12) is formed as plural penetrated holes (121) at the outer periphery of the chamber (11) of the pot body (10), and the penetrated holes (121) are arranged with intervals.

The lid (20) includes a lid body (21) and a placing member (22). The lid body (21) is covered on the pot body (10) corresponding to the chamber (11) of the pot body (10), and the interior of the lid body (21) is formed with an installation room (211).

The placing member (22) is protruded from the lid body (21) and is able to be received in the engaging member (12) of the pot body (10). The placing member (22) is formed as plural convex columns (221) protruded from the lid body (21), each of the convex columns (221) is respectively formed on the contact surface where the lid body (21) and the pot body (10) are in contact with each other, and the convex columns (221) are arranged with intervals and respectively corresponding to each of the penetrated holes (121), thereby enabling each of the convex columns (221) to be received in each of the penetrated holes (121).

The cooking pot (1) further includes a hot wind supplying module (30) installed in the installation room (211) of the lid body (21), and the hot wind supplying module (30) includes a blower, a driver and a heater.

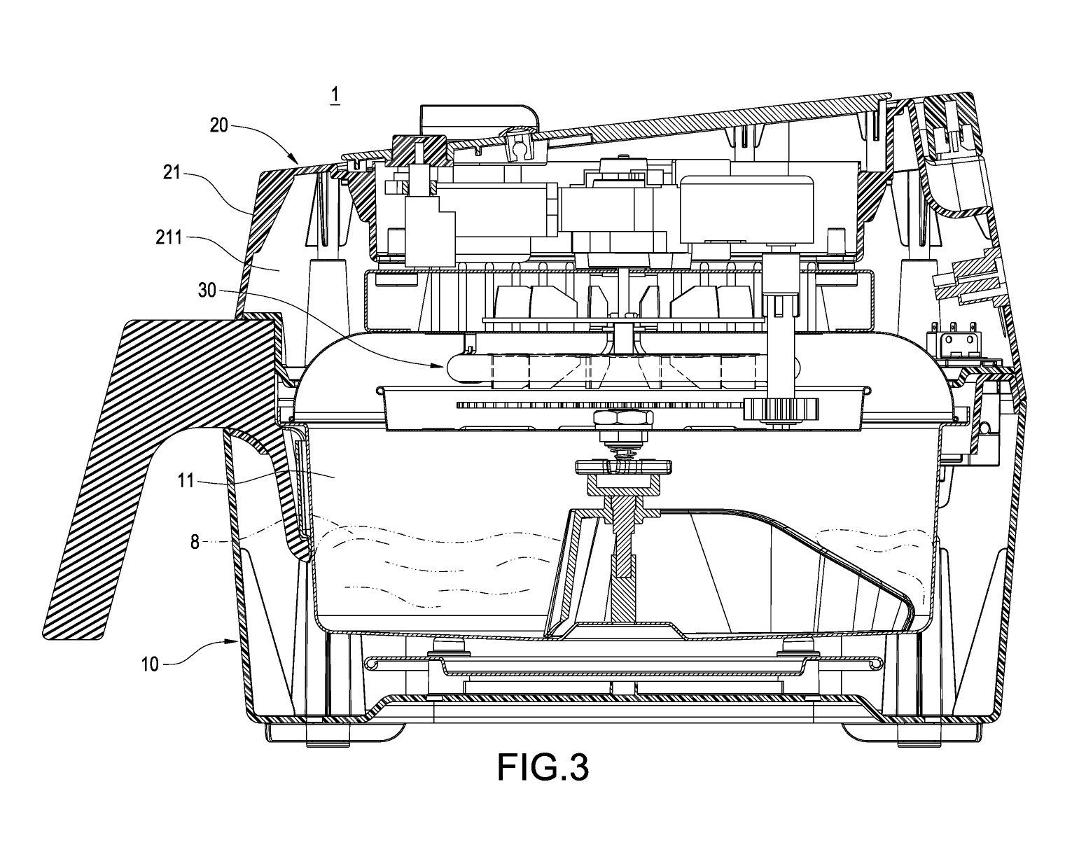

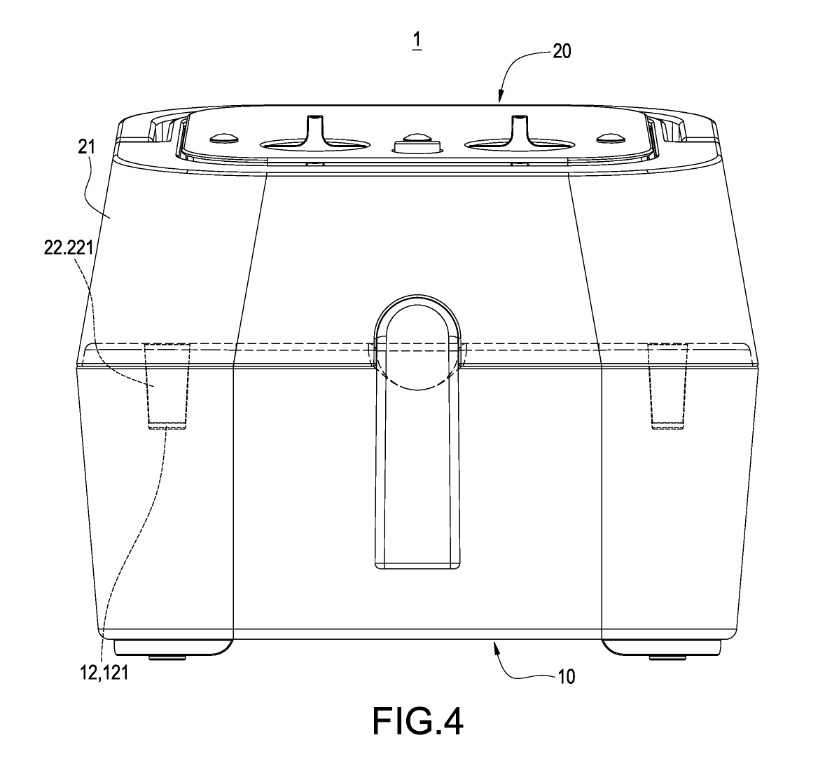

Please refer to FIG. 3 and FIG. 4, wherein FIG. 3 is a schematic view illustrating the cooking pot being in use according to the first embodiment of the present invention; and FIG. 4 is another schematic view illustrating the cooking pot being in use according to the first embodiment of the present invention. When in use, food (8) is placed in the chamber (11) of the pot body (10), then the lid (20 is covered on the pot body (10) corresponding to the chamber (11), and each of the convex columns (221) is correspondingly received in each of the penetrated holes (121), then the cooking pot (1) is actuated for operation thereby allowing the heater of the hot wind supplying module (30) to heat the air around the blower for becoming hot air, and the blower is driven to operate by the driver thereby allowing the hot air around the blower to become a hot wind for being blown into the chamber (11) of the pot body (10), so the food (8) in the chamber (11) is able to be heated through the hot wind.

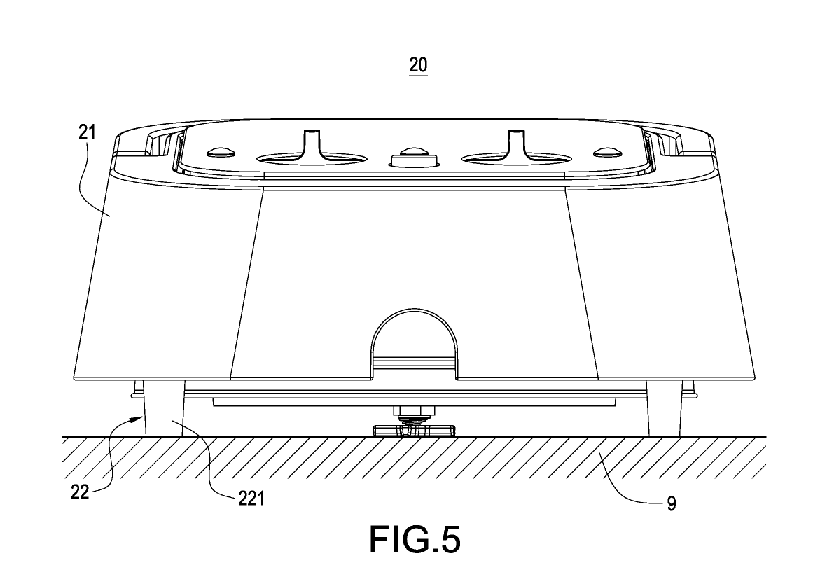

Please refer to FIG. 5, which is still another schematic view illustrating the cooking pot being in use according to the first embodiment of the present invention. When the cooking process of the food (8) in the chamber (11) is finished, the lid (20) is detached from the pot body (10), and then the lid (20) is placed on a tabletop (9), thereby allowing the food (8) in the chamber (11) of the pot body (10) to be easily taken out.

Wherein, when the lid (20) is desired to be placed on the tabletop (9), each of the convex columns (221) of the placing member (22) can be used for supporting the lid (20) on the tabletop (9), thereby preventing the lid (20) with high temperature from being in direct contact with the tabletop (9), so the conventional lid accommodation rack can be replaced thereby saving the expenditure or the production cost for the lid accommodation rack.

In addition, when the cooking pot (1) is desired to be used for cooking the food (8), with the design of the pot body (10) being installed with the engaging member (12), each of the convex columns (221) of the placing member (22) is allowed to be received in each of the penetrated holes (121) of the engaging member (12), and the lid (20) and the pot body (10) are enabled to be tightly combined, thereby preventing the hot wind provided by the hot wind supplying module (30) from being leaked from the gap formed between the pot body (10) and the lid (20).

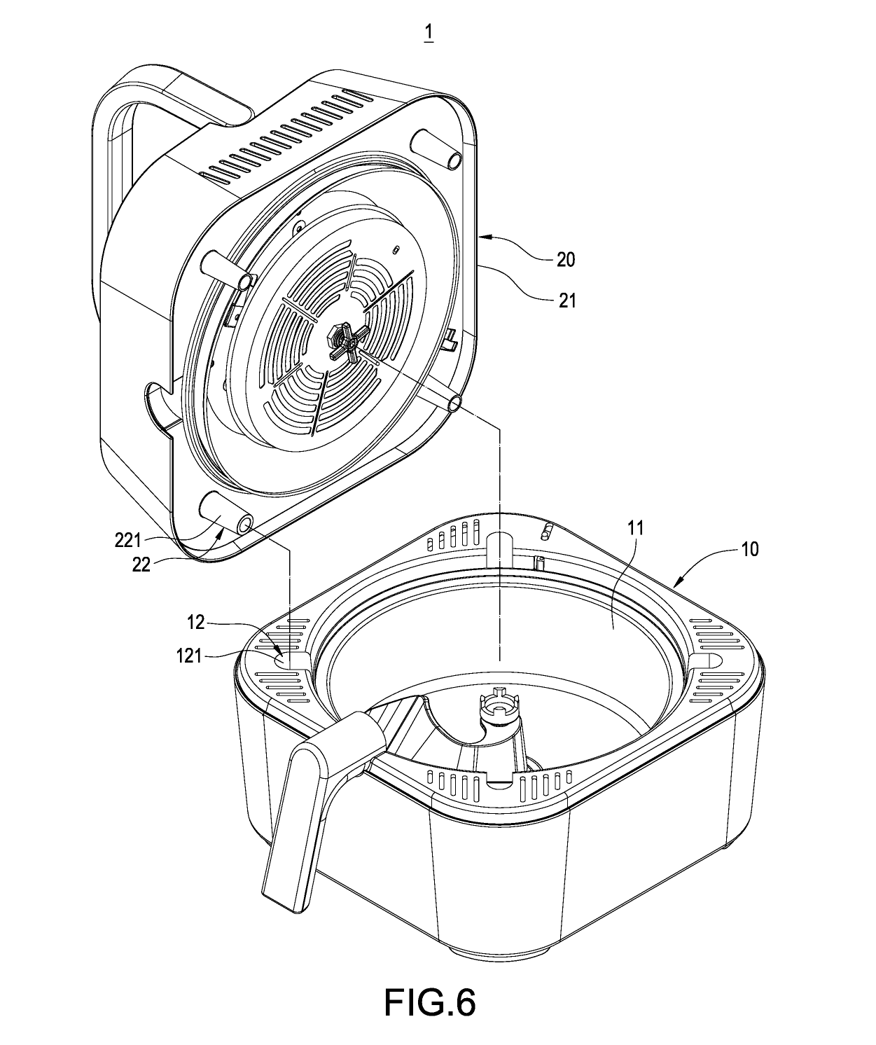

Please refer to FIG. 6, which is a schematic view showing the cooking pot according to a second embodiment of the present invention. The difference between this embodiment and the previous embodiment is that each of the penetrated holes (121) of the engaging member (12) is communicated with the chamber (11) of the pot body (10).

Accordingly, each of the convex columns (221) of the placing member (22) is still allowed to be received in each of the penetrated holes (121) of the engaging member (12), thereby enabling the lid (20) to be tightly combined with the pot body (10).

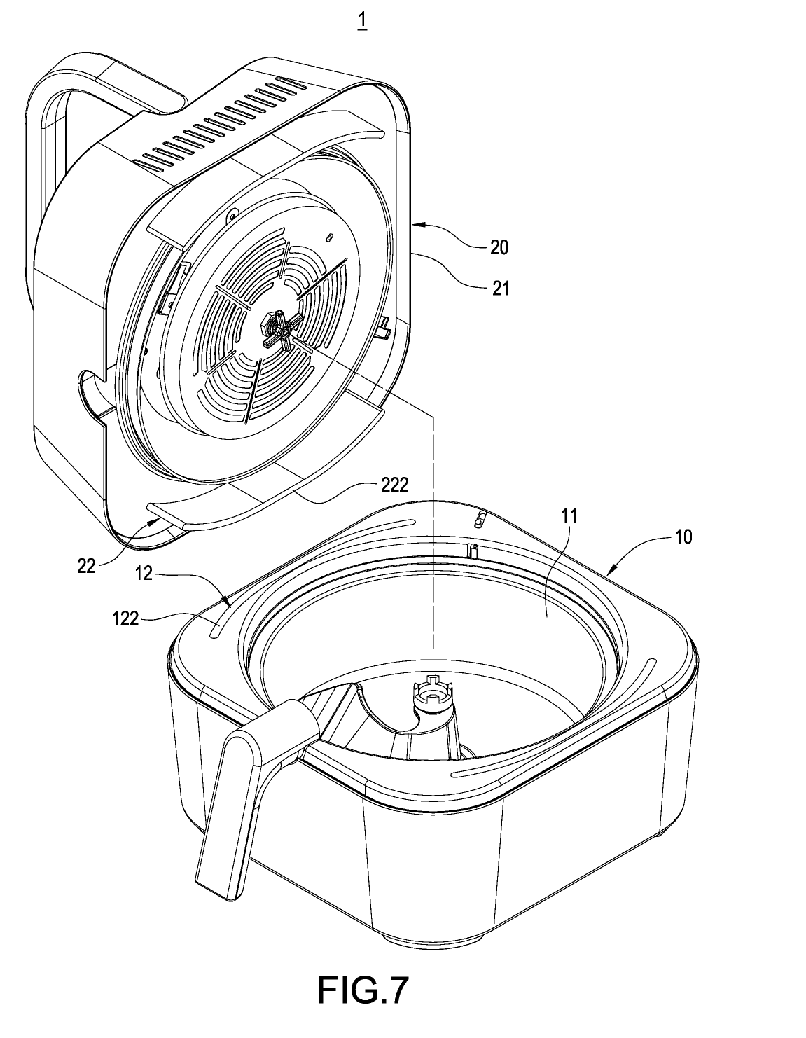

Please refer to FIG. 7, which is a schematic view showing the cooking pot according to a third embodiment of the present invention. The difference between this embodiment and the previous embodiments is that the placing member (22) is formed as plural arc-shaped plates (222) protruded from the lid body (21), each of the arc-shaped plates (222) is respectively formed on the contact surface where the lid body (21) and the pot body (10) are in contact with each other, and the arc-shaped plates (222) are arranged with intervals; the engaging member (12) is formed as plural arc-shaped grooves (122) at the outer periphery of the chamber (11) of the pot body (10), each of the arc-shaped grooves (122) is formed on an end surface of the pot body (10) adjacent to the lid body (21), the arc-shaped grooves (122) are arranged with intervals and respectively corresponding to each of the arc-shaped plates (222), and each of the arc-shaped plates (222) is able to be received in each of the arc-shaped grooves (122), so each of the arc-shaped plates (222) of the placing member (22) can be used for supporting the lid (20) on the tabletop (9), thereby preventing the lid (20) with high temperature from being in direct contact with the tabletop (9), so the conventional lid accommodation rack can be replaced thereby saving the expenditure or the production cost for the lid accommodation rack.

When the cooking pot (1) is desired to be used for cooking the food (8), each of the arc-shaped plates (222) of the placing member (22) is able to be received in each of the arc-shaped grooves (122) of the engaging member (12), thereby enabling the lid (20) to be tightly combined with the pot body (10).

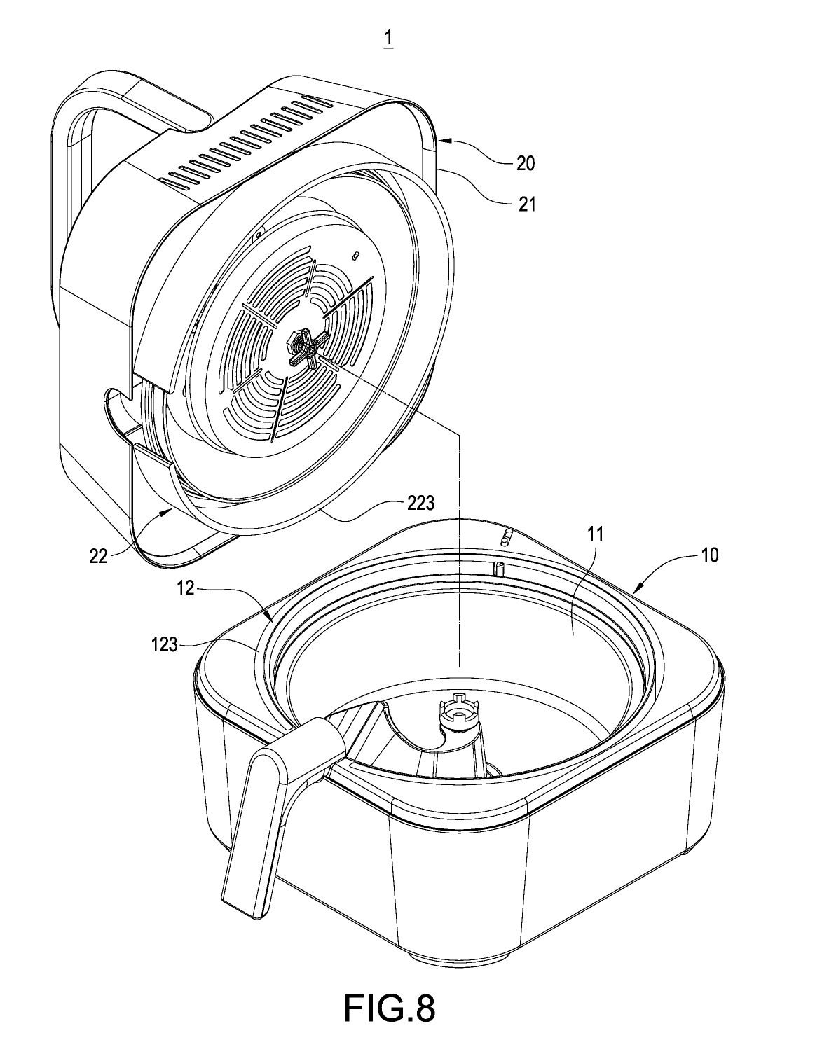

Please refer to FIG. 8, which is a schematic view showing the cooking pot according to a fourth embodiment of the present invention. The difference between this embodiment and the previous embodiments is that the placing member (22) is formed as a C-shaped annular plate (223) protruded from the lid body (21), the C-shaped annular plate (223) is formed on the contact surface where the lid body (21) and the pot body (10) are in contact with each other; the engaging member (12) is formed as a C-shaped annular groove (123) at the outer periphery of the chamber (11) of the pot body (10), the C-shaped annular groove (123) is formed on an end surface of the pot body (10) adjacent to the lid body (21), the C-shaped annular groove (123) is arranged corresponding to the C-shaped annular plate (223), and the C-shaped annular plate (223) is able to be received in the C-shaped annular groove (123); accordingly, the C-shaped annular plate (223) of the placing member (22) can be used for supporting the lid (20) on the tabletop (9), thereby preventing the lid (20) with high temperature from being in direct contact with the tabletop (9), so the conventional lid accommodation rack can be replaced thereby saving the expenditure or the production cost for the lid accommodation rack.

When the cooking pot (1) is desired to be used for cooking the food (8), the C-shaped annular plate (223) of the placing member (22) is able to be received in the C-shaped annular groove (123) of the engaging member (12), thereby enabling the lid (20) to be tightly combined with the pot body (10).

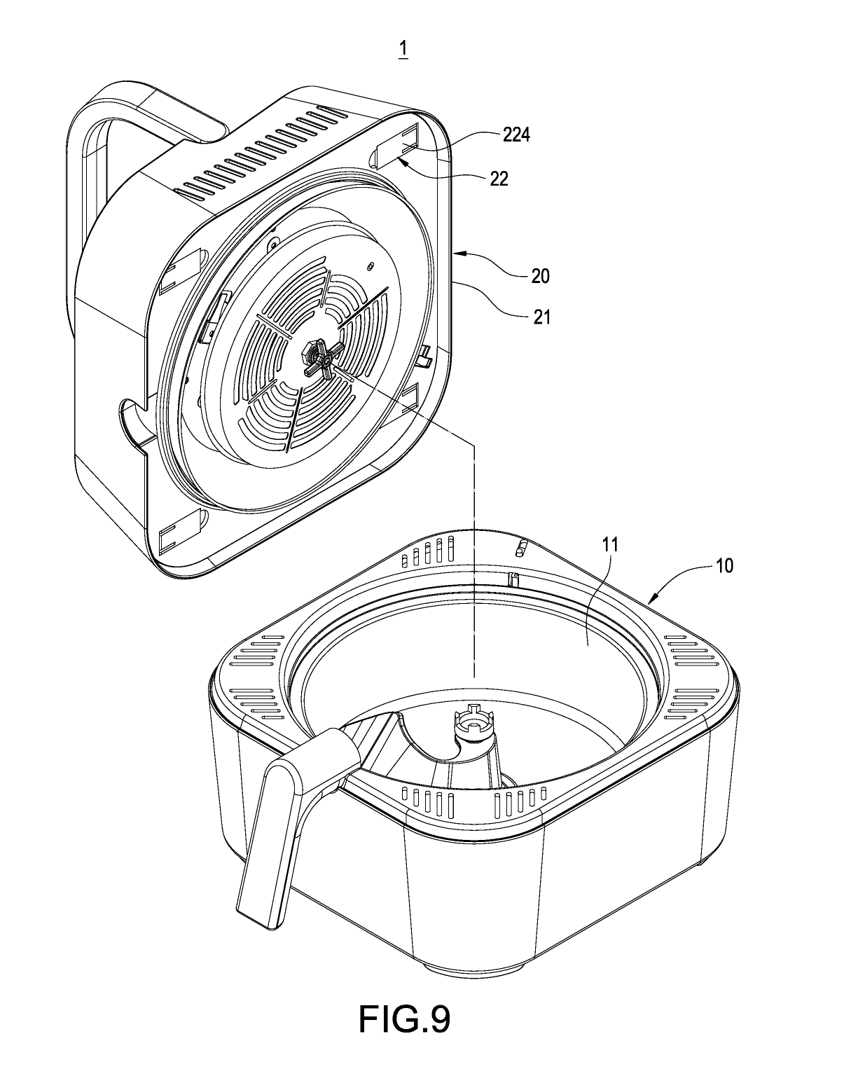

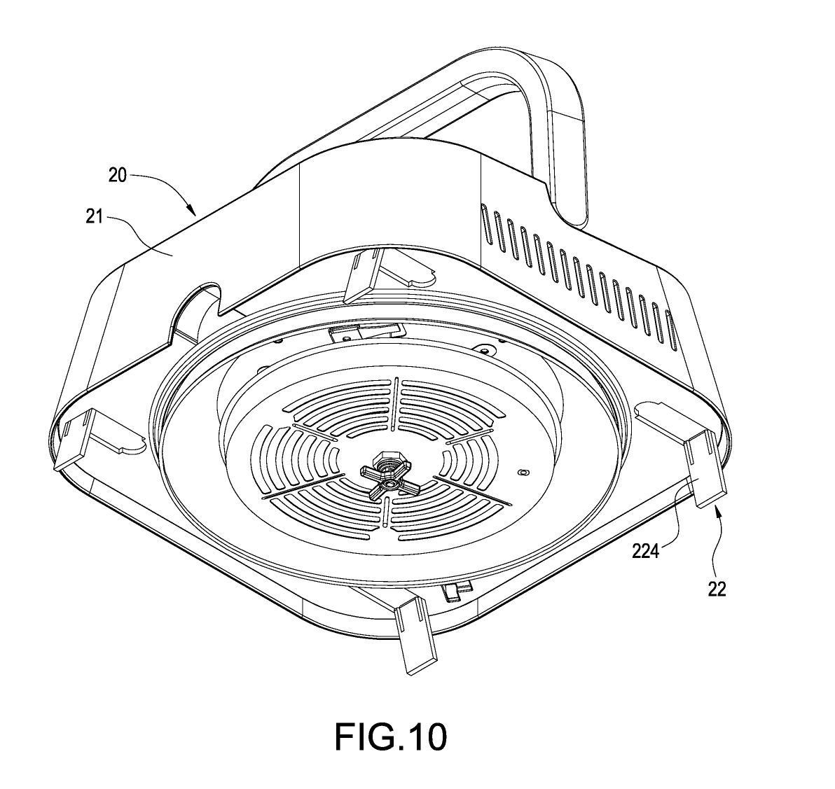

Please refer to FIG. 9 and FIG. 10, wherein FIG. 9 is a schematic view showing the cooking pot according to a fifth embodiment of the present invention. The difference between this embodiment and the previous embodiments is that the placing member (22) is formed as plural mobile supports (224) formed on the lid body (21). When the mobile supports (224) are not in use, each of the mobile supports (224) can be flatly disposed on a connection surface of the lid body (21) (as shown in FIG. 9). When the lid body (21) is required to be placed, each of the mobile supports (224) are downwardly pulled out for providing the support function (as shown in FIG. 10).

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A cooking pot (1) comprising:
a pot body (10), formed with a chamber (11) and an engaging member (12) installed on the pot body (10); and
a lid (20), including a lid body (21) and a placing member (22) protruded from the lid body (21), wherein the lid body (21) is covered corresponding to the chamber (11), and the placing member (22) is correspondingly received in the engaging member (12).

2. The cooking pot (1) according to claim 1, wherein the placing member (22) is formed as plural convex columns (221) arranged with intervals and formed on the contact surface of the lid body (21) and the pot body (10); the engaging member (12) is formed as plural penetrated holes (121) at the outer periphery of the chamber (11), and the penetrated holes (121) are arranged with intervals and respectively corresponding to each of the convex columns (221), thereby each of the convex columns (221) being able to be received in each of the penetrated holes (121).

3. The cooking pot (1) according to claim 2, wherein each of the penetrated holes (121) is communicated with the chamber (11).

4. The cooking pot (1) according to claim 1, wherein the placing member (22) is formed as plural arc-shaped plates (222) arranged with intervals on the contact surface of the lid body (21) and the pot body (10); the engaging member (12) is formed as plural arc-shaped grooves (122) at the outer periphery of the chamber (11), and the arc-shaped grooves (122) are arranged with intervals and respectively corresponding to each of the arc-shaped plates (222), thereby each of the arc-shaped plates (222) being able to be received in each of the arc-shaped grooves (122).

5. The cooking pot (1) according to claim 1, wherein the placing member (22) is formed as a C-shaped annular plate (223) on the contact surface of the lid body (21) and the pot body (10); the engaging member (12) is formed as a C-shaped annular groove (123) at the outer periphery of the chamber (11), and the C-shaped annular plate (223) is able to be received in the C-shaped annular groove (123).

6. The cooking pot (1) according to claim 1, wherein the placing member (22) is formed as plural mobile supports (224) arranged on the contact surface of the lid body (21) and the pot body (10).

7. The cooking pot (1) according to claim 1, further including a hot wind supplying module (30), wherein the interior of the lid body (21) is formed with an installation room (211) in which the hot wind supplying module (30) is installed.

8. A lid (20) of a cooking pot, including a lid body (21) and a placing member (22) protruded from the lid body (21).

9. The lid (20) of a cooking pot according to claim 8, wherein the placing member (22) is formed as plural convex columns (221) arranged with intervals.

10. The lid (20) of a cooking pot according to claim 8, wherein the placing member (22) is formed as plural arc-shaped plates (222) arranged with intervals.

11. The lid (20) of a cooking pot according to claim 8, wherein the placing member (22) is formed as a C-shaped annular plate (223).

12. The lid (20) of a cooking pot according to claim 8, wherein the placing member (22) is formed as plural mobile supports (224).
